(19) United States
(12) Patent Application Publication
(10) Pub. No.: US 2016/0021264 A1
(43) Pub. Date: Jan. 21, 2016

(54) INFORMATION PROCESSING SYSTEM, INFORMATION PROCESSING DEVICE, PORTABLE TERMINAL, AND NON-TRANSITORY COMPUTER READABLE MEDIUM

(71) Applicant: FUJI XEROX CO., LTD., Tokyo (JP)

(72) Inventors: Yuichi TAKEUCHI, Kanagawa (JP); Yasushi OSAWA, Kanagawa (JP)

(73) Assignee: FUJI XEROX CO., LTD., Tokyo (JP)

(21) Appl. No.: 14/614,962

(22) Filed: Feb. 5, 2015

(30) Foreign Application Priority Data
Jul. 18, 2014 (JP) 2014-147805

(51) Int. Cl. H04N 1/00; H04N 1/32

(52) U.S. Cl. CPC H04N 1/00204; H04N 1/00103; H04N 1/32379; H04N 1/32368; H04N 2201/0094; H04N 2201/0055; H04N 2201/0039; H04N 2201/3288

(57) ABSTRACT

An information processing system includes a portable terminal and an information processing device that is connected to a network via a first access point and that is connected to the portable terminal. The information processing device includes a connecting unit that connects a storage device provided with a wireless network function. The storage device connected by the connecting unit includes a communication unit that achieves the wireless network function, and the communication unit is used as a second access point used only for communication of data transmitted between the information processing device and the portable terminal. The storage device also includes data storage, and the data storage is used as a temporary storage area for the data transmitted via the second access point between the information processing device and the portable terminal.

### CROSS-REFERENCE TO RELATED APPLICATIONS

This application is based on and claims priority under 35 USC 119 from Japanese Patent Application No. 2014-147805 filed Jul. 18, 2014.

### BACKGROUND

### Technical Field

The present invention relates to an information processing system, an information processing device, a portable terminal, and a non-transitory computer readable medium.

### SUMMARY

According to an aspect of the invention, there is provided an information processing system including a portable terminal and an information processing device that is connected to a network via a first access point and that is connected to the portable terminal. The information processing device includes a connecting unit that connects a storage device provided with a wireless network function. The storage device connected by the connecting unit includes a communication unit that achieves the wireless network function, and the communication unit is used as a second access point used only for communication of data transmitted between the information processing device and the portable terminal. The storage device also includes data storage, and the data storage is used as a temporary storage area for the data transmitted via the second access point between the information processing device and the portable terminal.

### BRIEF DESCRIPTION OF THE DRAWINGS

Exemplary embodiments of the present invention will be described in detail based on the following figures, wherein:

FIG. 1 is a block diagram illustrating the configuration of an information processing system according to an exemplary embodiment of the present invention;

FIG. 2 is a diagram illustrating the hardware configuration of a multi-function device according to a first exemplary embodiment;

FIG. 3 is a diagram illustrating the hardware configuration of a computer included in a portable terminal according to the first exemplary embodiment;

FIG. 4 is a flowchart of a copy service process according to the first exemplary embodiment;

FIG. 5A is a flowchart of a scan service process according to a second exemplary embodiment;

FIG. 5B is a flowchart of a process of transferring scan data, which is subsequent to the process in FIG. 5A;

FIG. 6 is a diagram illustrating an exemplary screen on which a connection number is displayed and which is displayed on an operation panel of a portable terminal according to a second exemplary embodiment;

FIG. 7 is a diagram illustrating an exemplary screen on which a connection number is inputted and which is displayed on an operation panel of a multi-function device according to the second exemplary embodiment;

FIG. 8 is a diagram illustrating an exemplary screen displayed on the operation panel of the multi-function device when transmission of scan data is completed, according to the second exemplary embodiment;

FIG. 9 is a diagram illustrating an exemplary screen displayed on the operation panel of the portable terminal after scan data is received, according to the second exemplary embodiment; and

FIG. 10 is a flowchart of a part of a scan service process according to a third exemplary embodiment.

### DETAILED DESCRIPTION

Desirable exemplary embodiments of the present invention will be described below on the basis of the drawings.

### First Exemplary Embodiment

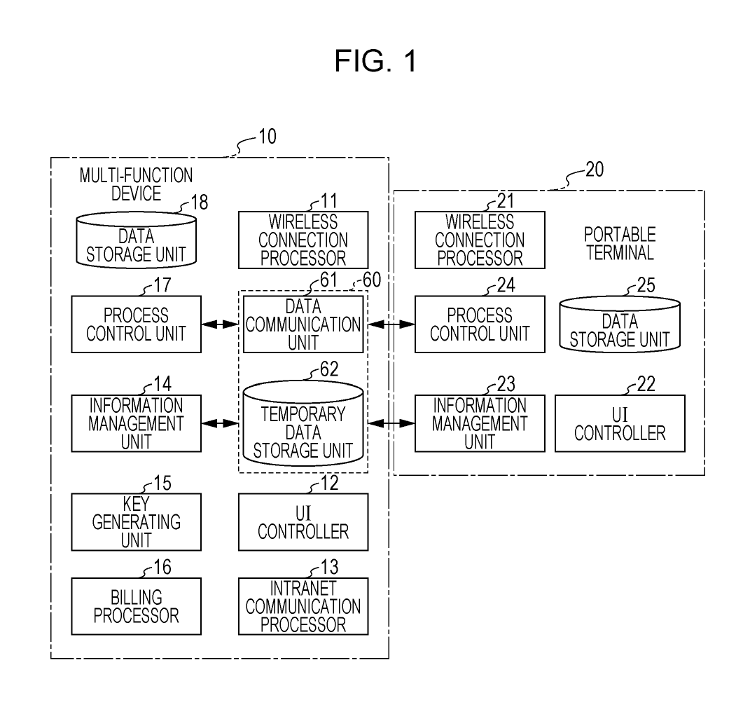

FIG. 1 is a block diagram illustrating the configuration of an information processing system according to an exemplary embodiment of the present invention. FIG. 1 illustrates a multi-function device 10 and a portable terminal 20. The multi-function device 10 disposed at a store such as a convenience store serves as an information processing device which provides various services, such as a scan service and a print service, for customers. In a first exemplary embodiment, the information processing device is incorporated in the multi-function device 10. However, a configuration may be employed in which a digital front end (DFE) corresponding to the information processing device is independent of the multi-function device which includes a scanner and a print engine and which provides various services. The portable terminal 20 is a portable terminal device carried by a customer (hereinafter referred to as a “user”), and is, for example, a smartphone or a tablet terminal.

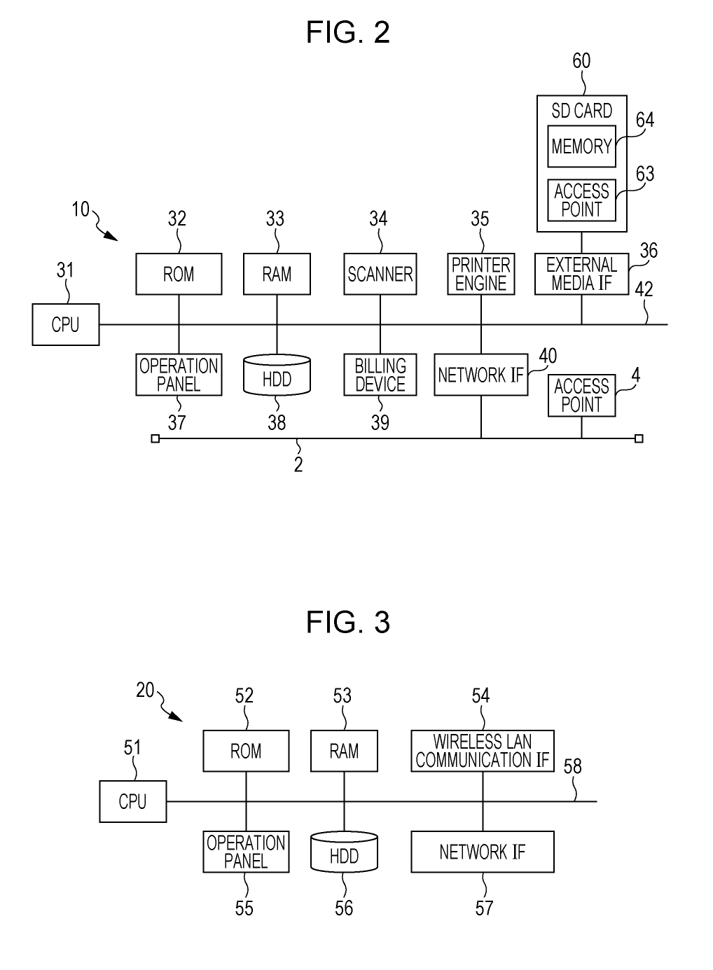

FIG. 2 is a diagram illustrating the hardware configuration of the multi-function device 10 according to the first exemplary embodiment. The multi-function device 10 is provided with various functions, such as a copy function and a scanner function, and includes a computer. In FIG. 2, a CPU 31 controls operations of various mechanisms, such as a scanner 34 and a printer engine 35, which are included in the multi-function device 10, in accordance with programs stored in a ROM 32. The ROM 32 stores various programs for controlling the multi-function device 10 and for providing various services, such as a print service and a scan service. A RAM 33 is used as a work memory for program execution and a communication buffer for transmission/reception of electronic data. The scanner 34 reads a document which is set by a user, and accumulates it as digital data in a hard disk drive (HDD) 38 or the like. The printer engine 35 prints an image on an output sheet in accordance with an instruction supplied from a control program executed by the CPU 31. An external media interface (IF) 36 is an interface with an external memory device, such as a Universal Serial Bus (USB) memory and a secure digital (SD) memory card. The external media interface 36 according to the first exemplary embodiment is provided as a connecting unit which connects a SD memory card (hereinafter simply referred to as a “SD card”) 60 which is mounted all the time. An operation panel 37 is a user interface unit which receives an instruction from a user and which displays information. The HDD 38 stores digital data such as an image read by the scanner 34. A billing device 39 is used in billing of a user using a service provided by the multi-function device 10. A network IF 40 establishes a wired connection to a local-area network (LAN) 2. Connection to the LAN 2 is established among devices, such as an access point 4 through which wireless LAN communication with a wireless LAN client through Wi-Fi is performed, a computer (not illustrated) used for the operation or the like of the store, and a communication unit to the main office, whereby an intranet is formed. An address data bus 42 is connected to various mechanisms which are control targets of the CPU 31, and provides data communication.

The SD card 60 used in the first exemplary embodiment is a storage device provided with a wireless LAN function, and includes an access point 63 serving as a communication unit for achieving a wireless network function, and a memory 64 serving as data storage. Although this configuration enables the multi-function device 10 in the first exemplary embodiment to perform data communication with a wireless LAN client via both of the access point 4 which is a first access point and the access point 63 which is a second access point, the access point 4 is used for the operation of the store, and the access point 63 is used for service provision for a user of the multi-function device 10. That is, the configuration is employed so that, when a user who is a service receiver uses a service supplied by using the portable terminal 20 and the multi-function device 10, the service is available without connection of the portable terminal 20 carried by the user to the access point 4, in other words, so that prohibition of connection of the portable terminal 20 to the access point 4 causes prohibition of access to a computer which is used for the operation of the store and which is connected to the LAN 2.

In the first exemplary embodiment, a “Wi-Fi connection” refers to a state in which a network connection is established in such a manner that the access point 63 is capable of communicating with the portable terminal 20 which is a wireless LAN client in accordance with the wireless LAN standard of Wi-Fi. Disconnection of a network connection according to Wi-Fi is expressed as disconnection of a Wi-Fi connection.

FIG. 3 is a diagram illustrating the hardware configuration of a computer included in the portable terminal 20 according to the first exemplary embodiment. As the portable terminal 20 according to the first exemplary embodiment, a portable terminal 20 of the related art may be used without modification. That is, the computer included in the portable terminal 20 may be implemented by using a general-purpose hardware configuration of the related art. As illustrated in FIG. 3, the computer has a configuration in which a CPU 51, a ROM 52, a RAM 53, a wireless LAN communication IF 54 through which wireless communication is performed by using Wi-Fi, an operation panel 55 which receives an instruction from a user and which displays information, an HDD 56, and a network IF 57 through which network communication with the outside is performed by using a communication system other than Wi-Fi are connected to a bus 58.

The devices 10 and 20 may be implemented by using a hardware configuration of the related art, and the hardware configurations illustrated in FIGS. 2 and 3 are examples. The first exemplary embodiment has characteristics in operational control performed by using programs executed by the CPUs 31 and 51.

Back to FIG. 1, the multi-function device 10 includes a wireless connection processor 11, a user interface (UI) controller 12, an intranet communication processor 13, an information management unit 14, a key generating unit 15, a billing processor 16, a process control unit 17, and a data storage unit 18. Components which are not used in the description of the first exemplary embodiment are omitted. The wireless connection processor 11 uses the access point 63 to establish a Wi-Fi connection to the portable terminal 20. The user interface controller 12 performs display control for the operation panel 37 and performs input control such as reception of information inputted by a user from the operation panel 37. The intranet communication processor 13 performs data communication via the LAN 2. The information management unit 14 stores and manages information, such as identification information and a key for the portable terminal 20. The key generating unit 15 generates a common key used for encryption/decoding of data received/transmitted from/to the portable terminal 20. The billing processor 16 operates cooperatively with the billing device 39 so as to perform a billing process such as a charge and a collection for a user using a service provided by the multi-function device 10.

The process control unit 17 is a process controller which controls execution of a process for providing a service specified by a user while the process control unit 17 operates cooperatively with the other components 11 to 16. When a user uses a print service, an application for the print service is activated, and a generated print job is executed. When a user uses a scan service, an application for the scan service is activated, and a generated scan job is executed.

The data storage unit 18 stores data received/transmitted from/to the portable terminal 20 via the SD card 60. When a print job is executed, the data storage unit 18 stores image data transmitted from the portable terminal 20. When a scan job is executed, the data storage unit 18 stores scan data generated through scanning performed by the scanner 34.

The components 11 to 17 in the multi-function device 10 are implemented through a cooperative operation between the hardware included in the multi-function device 10 and the programs executed by the CPU 31. The RAM 33 or the HDD 38 is used as a unit for storing data by the information management unit 14. The data storage unit 18 is implemented by using the HDD 38. As the storage, an external storage may be used via a network. However, in the first exemplary embodiment, data is stored by using the configuration in the multi-function device 10 in terms of security unless otherwise specified.

The SD card 60 included in the multi-function device 10 includes a data communication unit 61 which is implemented by using the access point 63 and which performs data communication with the portable terminal 20, and a temporary data storage unit 62 which is implemented by using the memory 64 and which is used as a temporary storage area for data transmitted between the multi-function device 10 and the portable terminal 20.

The portable terminal 20 includes a wireless connection processor 21, a UI controller 22, an information management unit 23, a process control unit 24, and a data storage unit 25. Components which are not used in the description in the first exemplary embodiment are omitted. The wireless connection processor 21 uses the wireless LAN communication IF 54 to establish a Wi-Fi connection to the multi-function device 10. The user interface controller 22 performs display control for the operation panel 55 and performs input control such as reception of information inputted by a user from the operation panel 55. The information management unit 23 functions as a notification unit which notifies the multi-function device 10 of a public key and a terminal identifier as identification information with which the portable terminal 20 is identifiable. The information management unit 23 stores and manages the terminal identifier, a private key, and information such as the common key obtained from the multi-function device 10.

The process control unit 24 is a process controller which controls execution of a process for receiving provision of a service specified by a user while the process control unit 24 operates cooperatively with the other components 21 to 23. When a user uses a print service, a process is performed in accordance with an activated application for the print service. When a user uses a scan service, a process is performed in accordance with an activated application for the scan service. In particular, the process control unit 24 according to the first exemplary embodiment functions as a data writing unit which writes data to be supplied to the multi-function device 10, via the data communication unit 61 into the temporary data storage unit 62.

The data storage unit 25 stores data received/transmitted from/to the multi-function device 10 via the SD card 60. When a print service is used, the data storage unit 25 stores image data which is to be printed and which is to be transmitted to the multi-function device 10. When a scan service is used, the data storage unit 25 stores digital data (scan data) of a document read by the scanner 34.

The components 21 to 24 in the portable terminal 20 are implemented through a cooperative operation between the hardware included in the portable terminal 20 and the programs executed by the CPU 51. The RAM 53 or the HDD 56 is used as a unit for storing data by the information management unit 23. The data storage unit 25 is implemented by using the HDD 56.

The programs used in the first exemplary embodiment may be provided not only through a communication unit but also by storing the programs in a computer-readable recording medium, such as a compact disc-read-only memory (CD-ROM) and a USB memory. The programs provided through a communication unit or a recording medium are installed in a computer, and the CPU of the computer sequentially performs the programs, whereby various processes are achieved.

When data is to be transmitted to the portable terminal 20, an application operated in the multi-function device 10 writes the data in a predetermined folder (corresponding to a “temporary storage area” described below) in the temporary data storage unit 62. An application operated in the portable terminal 20 checks if a read operation is to be performed on the temporary data storage unit 62, periodically every predetermined time interval, for example, every 200 milliseconds. More specifically, the application operated in the portable terminal 20 is provided in advance with a uniform resource locator (URL) (for example, http://example/) as a temporary storage area from the multi-function device 10. A browser is activated to access the URL, whereby the provided temporary storage area is accessed and checked if a read operation is to be performed. If new data is written in the temporary storage area, the data is obtained. In contrast, when data is to be transmitted to the multi-function device 10, the application operated in the portable terminal 20 writes the data in the temporary storage area specified by the URL by uploading the data to the area in the temporary data storage unit 62 which is specified by the URL. The application operated in the multi-function device 10 performs an operation of reading data from the predetermined folder of the temporary data storage unit 62, periodically every predetermined time interval, for example, every 100 milliseconds. If new data is written at that time, the data is obtained. Thus, to be exact, the data communication between the multi-function device 10 and the portable terminal 20 is performed through reading/writing from/to the temporary data storage unit 62 (memory 64) via the data communication unit 61 (access point 63) of the SD card 60. In the first exemplary embodiment, for the sake of convenience, description about an operation performed by the data communication unit 61 is skipped, and description will be made by using an expression of “transmission” to the multi-function device 10 or the portable terminal 20 and an expression of “reception” from the portable terminal 20 or the multi-function device 10.

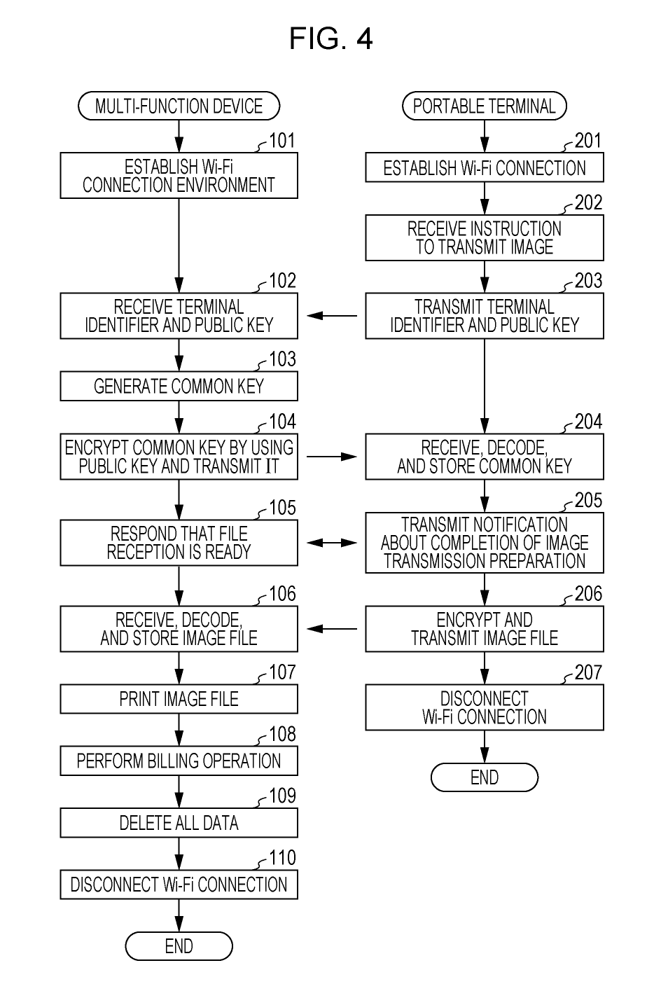

An operation according to the first exemplary embodiment will be described. In the first exemplary embodiment, a process flow in which a user carries the portable terminal 20 into a store such as a convenience store, and then uses a print service provided by the multi-function device 10 installed in the store to print an image stored in the portable terminal 20 by using the multi-function device 10 will be described by using the flowchart illustrated in FIG. 4.

When the user selects a print service from a service menu (not illustrated) displayed on the operation panel 37 of the multi-function device 10, an application for the print service is activated, and the processing functions of the components 11 to 17 in the multi-function device 10 are performed under control of the process control unit 17. The wireless connection processor 11 activates the access point 63 to establish an environment for enabling a Wi-Fi connection (in step 101). At that time, a message that it is required that the portable terminal 20 be connected may be displayed on the operation panel 37.

The user who has selected the print service performs a predetermined operation on the portable terminal 20, whereby a list of access points connectable to the portable terminal 20 is displayed on the operation panel 55. The user selects the service set identifier (SSID) of the access point 63 from the list. In response to the selection operation, the wireless connection processor 21 establishes a Wi-Fi connection to the access point 63 (in step 201). Then, the user activates an application for the print service installed in advance in the portable terminal 20. Thus, the processing functions of the components 22 to 24 in the portable terminal 20 are performed under control of the process control unit 24.

When the application in the portable terminal 20 is activated, the user interface controller 22 displays a selection screen for image files which is displayed on the operation panel 55, and the user operates the displayed selection screen to select an image file to be printed, from the image files stored in the data storage unit 25. Then, the user selects a transmission button, thereby giving an instruction to transmit the image file. When the process control unit 24 receives the transmission instruction (in step 202), the information management unit 23 transmits the terminal identifier of the portable terminal 20 and the public key of the application which are stored therein to the multi-function device 10 (in step 203).

When the information management unit 14 of the multi-function device 10 receives the terminal identifier and the public key of the application (in step 102), the key generating unit 15 generates a common key on the basis of the received public key (in step 103). After the key generating unit 15 encrypts the common key by using the public key of the application, the key generating unit 15 transmits the encrypted key to the portable terminal 20 (in step 104). When the information management unit 23 in the portable terminal 20 receives the common key, the information management unit 23 decodes the received common key by using the private key of the application which is stored in the application, and then stores it therein (in step 204).

As described above, when the image file is ready to be transmitted, the process control unit 24 notifies the multi-function device 10 of the state in which preparation of file transmission is completed and in which the file is ready to be transmitted (in step 205). In response to the notification, the process control unit 17 in the multi-function device 10 responds that file reception is ready (in step 105). If it is determined that the image file is not ready to be transmitted/received, this state may be recognized as occurrence of a connection error, and a message indicating this may be displayed on each of the operation panels 37 and 55.

When it is determined that the image file is ready to be transmitted/received, the process control unit 24 of the portable terminal 20 reads the image file selected as a print target from the data storage unit 25, encrypts the image file by using the common key, and then transmits it to the multi-function device 10 one piece by one piece (in step 206).

When the process control unit 17 in the multi-function device 10 receives the image file transmitted from the portable terminal 20, the process control unit 17 decodes the received image file by using the common key stored in the information management unit 14, and then stores it in the data storage unit 18 (in step 106). At that time, the process control unit 17 may notify the portable terminal 20 of completion of decoding and storage of the image file transmitted from the portable terminal 20. The process control unit 17 instructs the printer engine 35 to print the image file stored in the data storage unit 18 (in step 107). The process control unit 17 may cause the user interface controller 12 to display a file receiving screen when the image file is being received, and to display a print progress screen on which the number of print pages and the number of a page which is being subjected to printing are displayed, when printing is being executed. Similarly, in the portable terminal 20, a screen which indicates the state in accordance with the processing progress may be displayed on the operation panel 55.

The billing processor 16 performs a billing operation every time printing of an image file is completed (in step 108). As the method of payment, a usual method, such as one using cash or an integrated circuit (IC) card, may be used. Information about completion of payment or the like is transmitted to a server or the like in the store or the main office via the intranet communication processor 13.

As described above, when provision of the print service is completed, the process control unit 17 deletes all data such as the image file stored in the temporary data storage unit 62 (in step 109). The wireless connection processor 11 stops the access point 63 and disconnects the Wi-Fi connection (in step 110). On the operation panel 37 in the multi-function device 10, the display is switched to the main menu automatically in response to the completion of provision of the print service, or manually in response to a user operation. The state returns to an initial state in which a service is available.

Similarly, in the portable terminal 20, the wireless connection processor 21 disconnects the Wi-Fi connection to the multi-function device 10 (in step 207).

In the first exemplary embodiment, as described above, a print service is provided without connecting the portable terminal 20 to the access point 4 in execution of the print service.

### Second Exemplary Embodiment

In the first exemplary embodiment, a process performed when a print service is provided is described. In a second exemplary embodiment, a process performed when a scan service is provided for a user will be described. Most of the components are the same as those in the first exemplary embodiment. In the first exemplary embodiment, a process is controlled in accordance with an application for a print service. The second exemplary embodiment is different from the first exemplary embodiment in that a process is controlled in accordance with an application for a scan service. Thus, processing functions to be performed are slightly different. Specifically, the process control unit 17 in the second exemplary embodiment functions as a data writing unit which writes data to be provided for the portable terminal 20 into the temporary data storage unit 62, and a checking unit which checks a connection number as an identification number written in the temporary data storage unit 62 against a connection number received by the user interface controller 12. The user interface controller 12 functions as a display controller which controls display of a connection number written in the temporary data storage unit 62, and a receiving unit which receives a connection number inputted by a user.

In the portable terminal 20, the process control unit 24 functions as an acquiring unit which, when the multi-function device 10 writes data in the temporary data storage unit 62, acquires the data via the data communication unit 61. The information management unit 23 functions as an identification-number writing unit which writes a connection number via the data communication unit 61 in the temporary data storage unit 62.

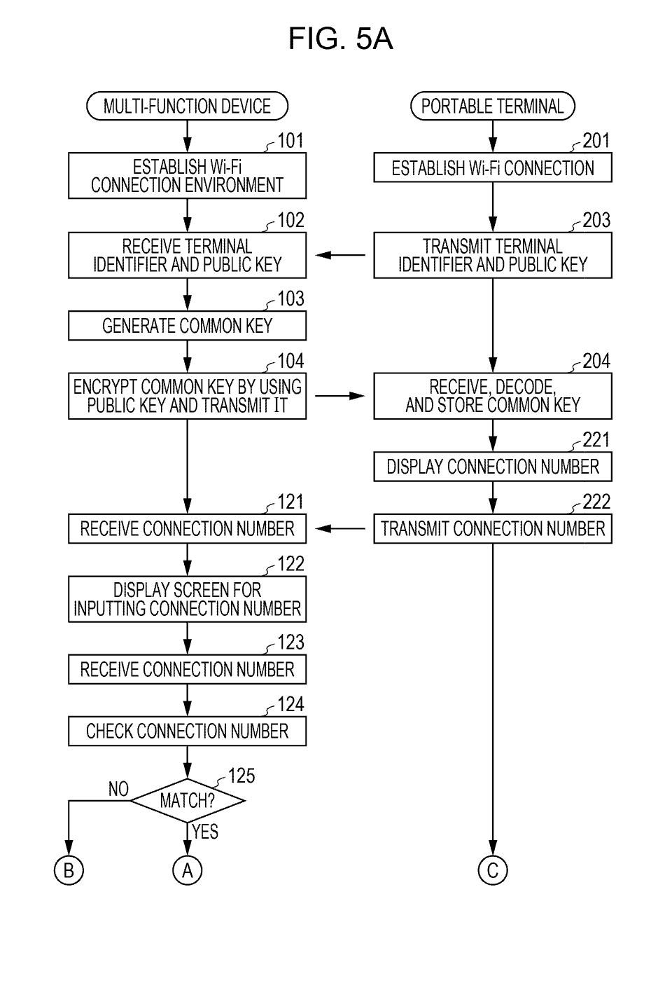

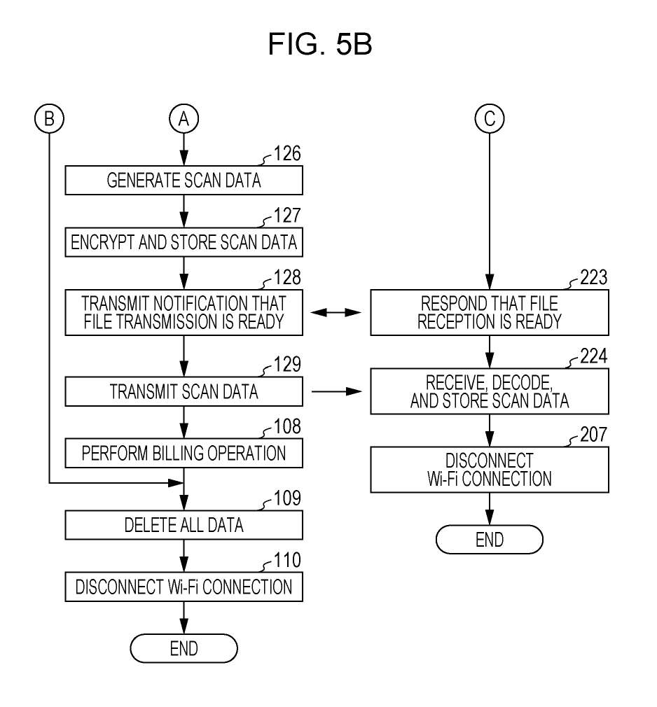

A process flow in which a user carries the portable terminal 20 and a document into a store such as a convenience store, and then uses a scan service provided by the multi-function device 10 installed in the store to store digital data of the document in the portable terminal 20 will be described below by using the flowchart illustrated in FIGS. 5A and 5B. In FIGS. 5A and 5B, the same processes as those in FIG. 4 are designated with the identical step numbers, and will not be described as appropriate.

When the user selects a scan service from a service menu (not illustrated) displayed on the operation panel 37 of the multi-function device 10, an application for the scan service is activated, and the wireless connection processor 11 activates the access point 63 to establish an environment for enabling a Wi-Fi connection (in step 101). When the user performs a predetermined operation on the portable terminal 20, the wireless connection processor 21 establishes a Wi-Fi connection to the access point 63 (in step 201).

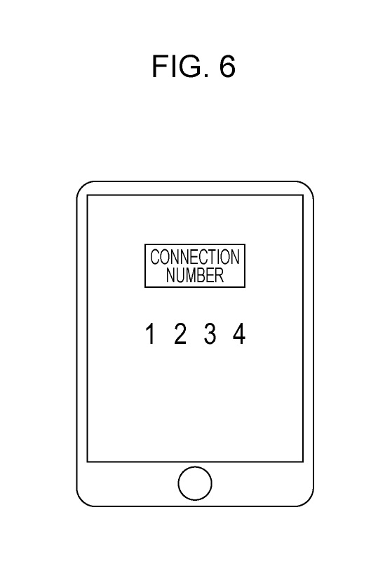

When the user activates an application for the scan service installed in advance in the portable terminal 20, the information management unit 23 transmits the terminal identifier of the portable terminal 20 and the public key of the application which are stored therein, to the multi-function device 10, obtains a common key generated by the multi-function device 10 in response to the transmission, and stores it therein (in steps 102 to 104 and steps 203 to 204). The information management unit 23 sets a connection number used in order that the application in the multi-function device 10 specifies the portable terminal 20. The connection number may be a number determined by the application randomly, and, for example, any string such as alphanumeric characters having any length may be used. The user interface controller 22 displays the connection number on the operation panel 55 (in step 221). FIG. 6 illustrates an exemplary display on the operation panel 55. The information management unit 23 stores the connection number therein which has been set, and transmits control information including the connection number to the multi-function device 10 (in step 222).

Transmission of the public key or the like may be subsequent to transmission of the control information, and vice versa. In order that the portable terminal 20 surely obtains all pieces of scan data, information about the free space of the HDD 56 may be transmitted along with the public key or the like to the multi-function device 10 so that it is checked in advance if the free space is enough.

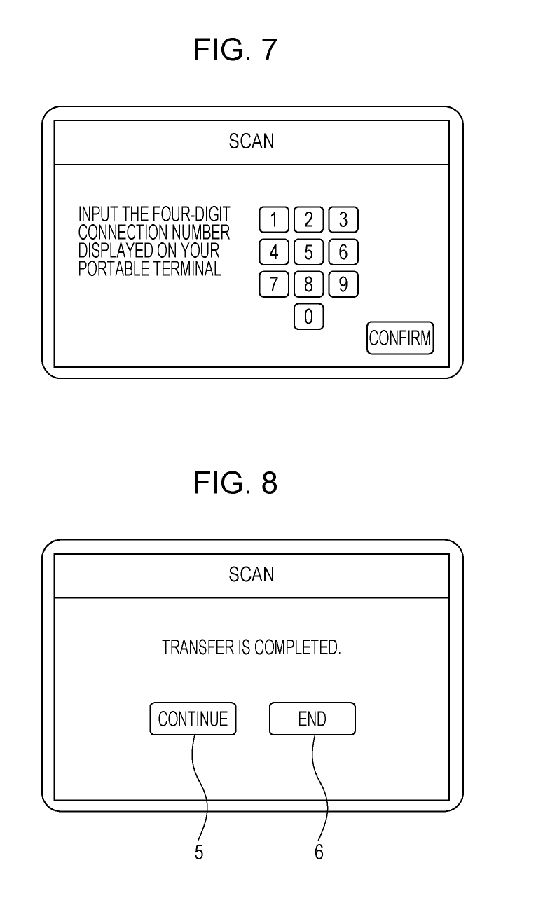

When the information management unit 14 in the multi-function device 10 receives the control information transmitted from the portable terminal 20 (in step 121), the information management unit 14 stores it therein, and the user interface controller 12 displays an input screen for inputting a connection number on the operation panel 37 (in step 122). FIG. 7 illustrates an exemplary display on the operation panel 37.

The user inputs the connection number displayed on the portable terminal 20 from the input screen for a connection number. When the user interface controller 12 receives the connection number (in step 123), the process control unit 17 checks the connection number inputted by the user against the connection number stored in the information management unit 14 (in step 124). If the check result is that the connection numbers do not match each other (NO in step 125), the operator of the multi-function device 10 is determined not to be a user who is to receive scan data of the document, and all pieces of information stored in the information management unit 14 in the above-described process are deleted (in step 109). The Wi-Fi connection to the portable terminal 20 is disconnected, whereby the process ends (in step 110). As a matter of course, in consideration of a typing mistake made by the user, the connection number may be retyped several times.

If the check result is that the connection numbers match each other (YES in step 125), the user interface controller 12 displays, for example, a message that a document is to be read by the scanner 34, on the operation panel 37. In response to this, the user uses the scanner 34 to read the document, whereby scan data is generated (in step 126). Then, the process control unit 17 encrypts the scan data by using the common key, and stores it in the data storage unit 18 (in step 127). The process control unit 17 notifies the portable terminal 20 of the state in which preparation of file transmission is completed and in which the file is ready to be transmitted (in step 128). In response to this notification, the process control unit 24 in the portable terminal 20 responds that file reception is ready (in step 223). If it is determined that the image file is not ready to be transmitted/received, this state may be recognized as occurrence of a connection error, and a message indicating this may be displayed on each of the operation panels 37 and 55.

When it is determined that the scan data is ready to be transmitted/received, the process control unit 17 of the multi-function device 10 reads the encrypted scan data from the data storage unit 18, and sequentially transmits it to the portable terminal 20 (in step 129). In the second exemplary embodiment, one scan data file is generated for one page in the document. Therefore, the sequential transmission means that the files are sequentially transmitted.

When the process control unit 24 in the portable terminal 20 receives the scan data transmitted from the multi-function device 10, the process control unit 24 uses the common key stored in the information management unit 23 to decode the received scan data, and stores it in the data storage unit 25 (in step 224). At that time, the process control unit 24 notifies the multi-function device 10 of completion of decoding and storage of the image files transmitted from the multi-function device 10.

The process control unit 17 may cause the user interface controller 12 to display a transmission progress screen on which the number of document pages, the number of transmitted pages, and the like are displayed, during transmission of the scan data (files). Similarly, in the portable terminal 20, a screen on which the reception state is displayed in accordance with the progress of the process may be displayed on the operation panel 55.

After the billing (in step 108), the multi-function device 10 deletes all pieces of the san data stored in the data storage unit 18 and the data stored in the information management unit 14 (in step 109), and the Wi-Fi connection is disconnected (in step 110). In the portable terminal 20, the Wi-Fi connection to the multi-function device 10 is disconnected (in step 207).

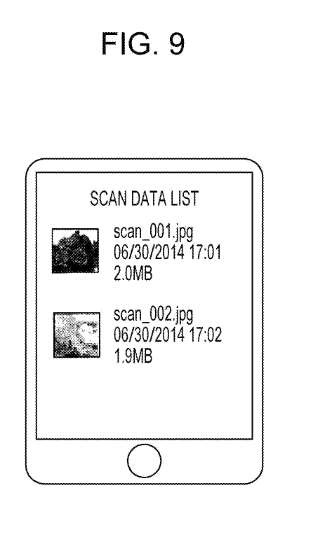

When the transmission of the scan data described above is completed, the user interface controller 12 may display, for example, a process completion screen illustrated in FIG. 8 on the operation panel 37. When the user selects a continuation button 5, a screen for further scanning a document may be displayed again. When the user selects an end button 6, provision of the scan service may be ended, and the service menu may be displayed. In the portable terminal 20, as illustrated in FIG. 9, a list of obtained scan files of the document may be displayed.

### Third Exemplary Embodiment

In a third exemplary embodiment, provision of a scan service in which a process different from that in the second exemplary embodiment is performed, for a user will be described. Most of the components are the same as those in the second exemplary embodiment. However, the process control unit 17 in the third exemplary embodiment functions as a generating unit which generates a temporary storage area (folder) named on the basis of the terminal identifier transmitted from the portable terminal 20, in the temporary data storage unit 62.

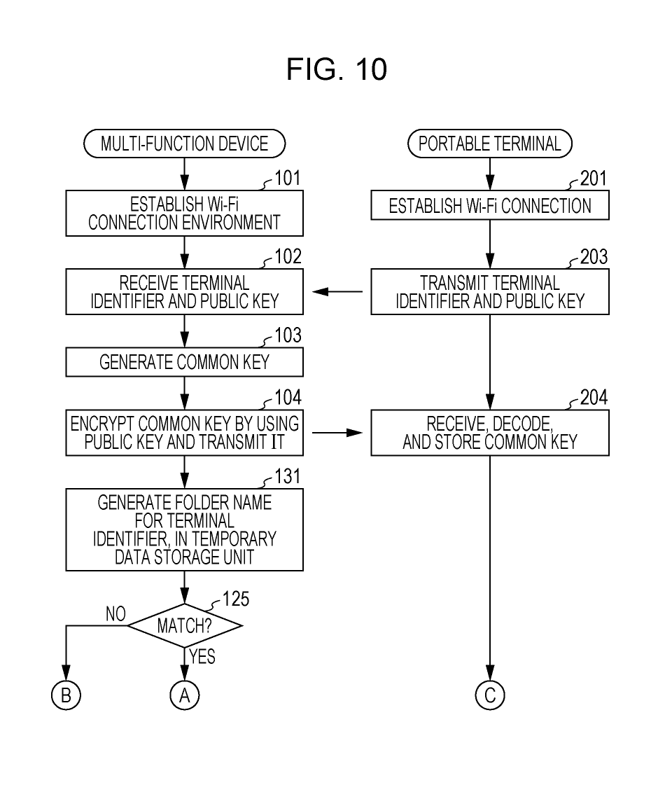

A process flow in which a user carries the portable terminal 20 and a document into a store such as a convenience store, and then uses a scan service provided by the multi-function device 10 installed in the store to store digital data of the document in the portable terminal 20 will be described below by using the flowchart illustrated in FIG. 10. The process subsequent to that in FIG. 10 is the same as that in FIG. 5B. In FIG. 10, the same processes as those in FIGS. 5A and 5B are designated with the identical step numbers, and will not be described as appropriate.

The process from the step in which the user selects a scan service from the service menu (not illustrated) to the step in which the common key is generated and stored in the portable terminal 20 may be the same as that in the second exemplary embodiment (in steps 101 to 104 and steps 201 to 204).

Then, the process control unit 17 in the third exemplary embodiment generates a folder named for the terminal identifier, in the temporary data storage unit 62 (in step 131). The scan data generated through scanning is encrypted and transmitted to the portable terminal 20 (in step 126 to 129). At that time, the encrypted scan data is written in the folder generated in step 131.

The process control unit 24 in the portable terminal 20 receives the scan data transmitted from the multi-function device 10 (in step 224). At that time, the process control unit 24 monitors writing into the folder named for the terminal identifier of the portable terminal 20 constantly. When scan data is written in the folder, the scan data is read and obtained. Specifically, for example, when the terminal identifier is “abcd”, the URL (http://example/abcd/) is accessed, and files written in the accessed folder are obtained.

Even when multiple users establish a connection to the access point 63 at the same time, services are available only to one user, as a rule. Simultaneous use by multiple users is prohibited. When a user ends use of a service, all pieces of personal data (such as scan data and a key) stored in the multi-function device 10 during use of the service are deleted from the viewpoint of maintenance of security. If use of an operation or another method eliminates security problems, personal data may be left in the multi-function device 10. In consideration of this, in the multi-function device 10 according to the third exemplary embodiment, scan data is written in the SD card 60 so as to be classified into temporary storage areas (folders) allocated by using the identifiers of portable terminals 20. In the multi-function device 10 in which simultaneous use by multiple users is originally not prohibited, it is effective to receive/transmit data through folders generated for respective portable terminals 20.

In the third exemplary embodiment, a terminal identifier is used as identification information for identifying the portable terminal 20. Scan data is transmitted between the multi-function device 10 and the portable terminal 20 via a folder named for the terminal identifier. If it is possible to transmit scan data between the multi-function device 10 and the portable terminal 20 and if it is possible to name folders in such a manner that folders for multiple portable terminals 20 do not have the same name, it is not necessary to use a terminal identifier as a folder name as described above. For example, a terminal identifier may be edited according to a predetermined rule, or a folder name may be generated according to a predetermined rule on the basis of identification information other than a terminal identifier.

In the exemplary embodiments described above, a process in which data is transmitted between the multi-function device 10 and the portable terminal 20 is described by taking a print service and a scan service as examples. The present invention may be applied to another service in which data is transmitted/received.

In the exemplary embodiments, the description is made by assuming the multi-function device 10 installed in a store such as a convenience store, in other words, the multi-function device 10 which is installed in public and which is used by a large number of unspecified customers. The above-described configuration may be applied to a multi-function device installed at a place other than a store.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a portable terminal; and
an information processing device that is connected to a network via a first access point and that is connected to the portable terminal,
wherein the information processing device includes a connecting unit that connects a storage device provided with a wireless network function,
wherein the storage device connected by the connecting unit includes a communication unit that achieves the wireless network function, and the communication unit is used as a second access point used only for communication of data transmitted between the information processing device and the portable terminal, and
wherein the storage device also includes data storage, and the data storage is used as a temporary storage area for the data transmitted via the second access point between the information processing device and the portable terminal.

2. The information processing system according to claim 1,
wherein the portable terminal includes a data writing unit that writes data via the second access point in the data storage, the data being provided for the information processing device, and
wherein the information processing device includes a process controller that, when the portable terminal writes data in the data storage, controls execution of a process on the data, the process being specified by a user.

3. The information processing system according to claim 1,
wherein the information processing device includes a data writing unit that writes data in the data storage, the data being provided for the portable terminal, and
wherein the portable terminal includes an acquiring unit that, when the information processing device writes data in the data storage, acquires the data via the second access point.

4. The information processing system according to claim 3,
wherein the portable terminal includes
a display controller that controls display of an identification number, and
an identification-number writing unit that writes the identification number via the second access point in the data storage,
wherein the information processing device includes
a receiving unit that receives an identification number inputted by a user,
a checking unit that checks the identification number written in the data storage against the identification number received by the receiving unit, and
a process controller that, when the checking result obtained by the checking unit is that the identification numbers match each other, controls execution of a process specified by the user, and
wherein the data writing unit writes data in the data storage, the data being obtained as an execution result of the process whose execution is controlled by the process controller.

5. The information processing system according to claim 3,
wherein the portable terminal includes a notification unit that notifies the information processing device of identification information for identifying the portable terminal,
wherein the information processing device includes a generating unit that generates a temporary storage area in the data storage, the temporary storage area having a name based on the identification information transmitted from the portable terminal, and
wherein the data writing unit writes data in the temporary storage area in the data storage, the data being provided for the portable terminal, the temporary storage area being generated on a basis of the identification information of the portable terminal.

6. An information processing device comprising:
a connecting unit that connects a storage device provided with a wireless network function,
wherein the storage device connected by the connecting unit includes a communication unit that achieves the wireless network function, and the communication unit is used as a second access point used only for communication of data transmitted between the information processing device and a portable terminal, the second access point being different from a first access point via which the information processing device is connected to a network, and
wherein the storage device also includes data storage, and the data storage is used as a temporary storage area for data transmitted via the second access point between the information processing device and the portable terminal.

7. A non-transitory computer readable medium storing a program causing a computer to execute a process, the computer being connected to a network via a first access point, the process comprising:
connecting a storage device provided with a wireless network function, the storage device including a communication unit and data storage, the communication unit achieving the wireless network function,
using the communication unit as a second access point used only for communication of data received from or transmitted to a portable terminal, and
using the data storage as a temporary storage area for data received from or transmitted to the portable terminal via the second access point.

8. A portable terminal comprising:
a unit that uses a communication unit as a second access point and that uses data storage as a temporary storage area, the communication unit and the storage device being included in a storage device provided with a wireless network function, the communication unit achieving the wireless network function, the storage device being connected to an information processing device connected to a network via a first access point, the second access point being used only for communication of data received from or transmitted to the information processing device, the temporary storage area storing data received from or transmitted to the information processing device via the second access point.

9. A non-transitory computer readable medium storing a program causing a computer to execute a process comprising:
using a communication unit as a second access point, the communication unit being included in a storage device provided with a wireless network function, and achieving the wireless network function, the storage device being connected to an information processing device connected to a network via a first access point, the second access point being used only for communication of data received from or transmitted to the information processing device, and
using data storage as a temporary storage area, the data storage being included in the storage device, the temporary storage area storing data received from or transmitted to the information processing device via the second access point.
